(19) United States
(12) Patent Application Publication
(10) Pub. No.: US 2005/0173023 A1
(43) Pub. Date: Aug. 11, 2005

(54) Configurations and designs for stump grinding teeth and corresponding holding

(76) Inventor: Guofang Cao, Diamond Bar, CA (US)

Correspondence Address: LAW OFFICES OF J.F. LEE, 17800 CASTLETON STREET, SUITE 383, CITY OF INDUSTRY, CA, 91748, US

(21) Appl. No.: 10/777,868

(22) Filed: Feb. 11, 2004

(51) Int. Cl. B27M 3/00; A01G 23/06; B27C 1/00; B27C 5/00; B27G 13/00

(52) U.S. Cl. 144/24.12; 144/176

(57) ABSTRACT

A new design and configuration for tree stump cutting tooth and its corresponding holding block. Instead of having holes on the tooth, open slots are used, so that replacement of worn-out tooth is easier, because bolts need only be loosened and not completely removed. The use of rib/groove structure eases the task of alignment at time of installing teeth to disc, and increases the clamping power of the holding block to the tooth.

### FIELD AND BACKGROUND OF THE INVENTION

The present invention relates generally to design and configuration of teeth and corresponding holding blocks used on machines for tree stump cutting and grinding.

Modern tree stump cutting and grinding machines in general have a rotary disc (or wheel) driven by motor; the disc has multiple teeth attached at the outer edge of the disc so that when the disc is spinning/rotating, the teeth on the edge repeatedly cuts towards the tree stump, or any work piece.

In all the prior art tooth structures, and in use today, each cutting tooth is installed to the rotary disc in one of two ways: the first is by bolting the tooth directly, through two holes at the back portion of the tooth, to the disc; the second is to have a holding block pressing the outside of a tooth, bolting towards the disc.

The disadvantage of the current art is that in order to replace a cutting tooth, the bolts have to be loosened and completed removed. It's a time-consuming process when damages to cutting tooth or other parts of the cutting machine require replacement of some teeth.

### OBJECTS AND SUMMARY OF THE INVENTION

Present invention provides an improved design and configuration for installing teeth to the rotary disc, by making open slots on the teeth, so that installing teeth will take less time, and consequently, tree stump cutting can be made more efficient.

### DESCRIPTION OF THE DRAWINGS

The accompanying drawings, which are incorporated in and constitute a part of this specification, illustrate the preferred embodiment of the invention and together with the description, serve to explain the principles of the invention.

A brief description of the drawings is as follows:

FIGS. 1a and 1b show the perspective views of a cutting tooth and its holding block. Instead of two holes on the tooth, there are two slots opening centripetally. On the block and the tooth, there are corresponding ribs and grooves.

FIGS. 2a and 2b show the side views of a cutting tooth and its holding block.

FIG. 3 shows an assembled view of the tooth and holding block in FIGS. 1 and 2.

FIGS. 4a and 4b show the perspective views of a cutting tooth and its holding block. There is only one open slot on the tooth and is oriented in the tangential direction to the rotary disc.

FIGS. 5a and 5b show the side views of a cutting tooth with tangential opening slot and its holding block.

FIGS. 6a and 6b show the perspective views of a tooth and its holding block. The rib/groove can be broken into segments.

FIGS. 7a and 7b show the perspective views of a tooth and its holding block. One side of the holding block is curved outward, instead of flat; the side of the tooth to be pressed against the holding block is made correspondingly curved inward.

FIGS. 8a and 8b show the perspective views of a tooth and its holding block. The surface curvature of the tooth and holding block is the reverse of FIGS. 7a and 7b.

FIGS. 9a and 9b show the perspective views of a tooth and its holding block. The slot on the tooth has wider opening. A pair of grooves on the two sides of the slot opening, however, still provides more than enough clamping power when the tooth is installed to the rotary disc; the ribs on the holding block being tightly meshed into the grooves.

FIGS. 10a and 10b show the side views of a tooth and its holding block, discussed in FIGS. 9a and 9b.

FIG. 11 shows a perspective view of a tooth, having wide slot opening centripetally. Its corresponding holding block would be the equivalent of FIG. 9b. Corresponding ribs and grooves are made to the tooth and block.

FIG. 12 shows a perspective view of a tooth, having one mid-portion extending centripetally, to form two wide-angled slots. Its corresponding holding block would be the equivalent of FIG. 9b. Corresponding ribs and grooves are made to the tooth and block.

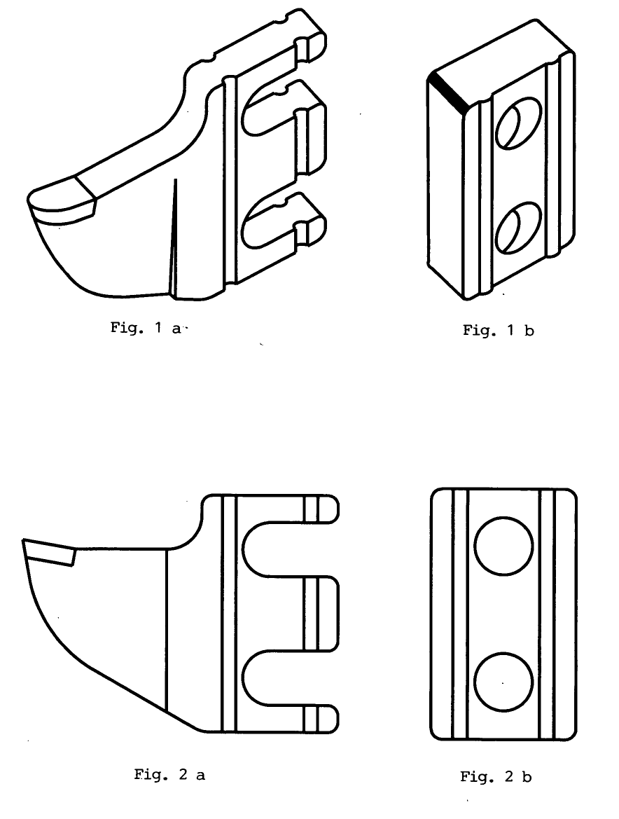

### DETAILED DESCRIPTION OF THE PREFERRED EMBODIMENT

In FIG. 3, the first preferred configuration of present invention is shown. When a cutting tooth is installed to the rotary disc, two bolts are screwed in so that the holding block presses tightly on one side of the tooth.

In FIG. 3, and in all other drawings of present invention, ribs and grooves are made on tooth and holding block to provide better alignment at time of installation, and also to provide better clamping effect.

Two bolts are commonly used for installation of the tooth and holding block to the rotary disc. However, three or more bolts sometimes can be found, depending on the size of the machines and bolts. Because open slots are used on the tooth, replacement of worn tooth is made easier. Instead of removing the bolts completely, a worker needs only loosen the bolts, take out the worn tooth, and put in a new tooth, and quickly tighten the bolts.

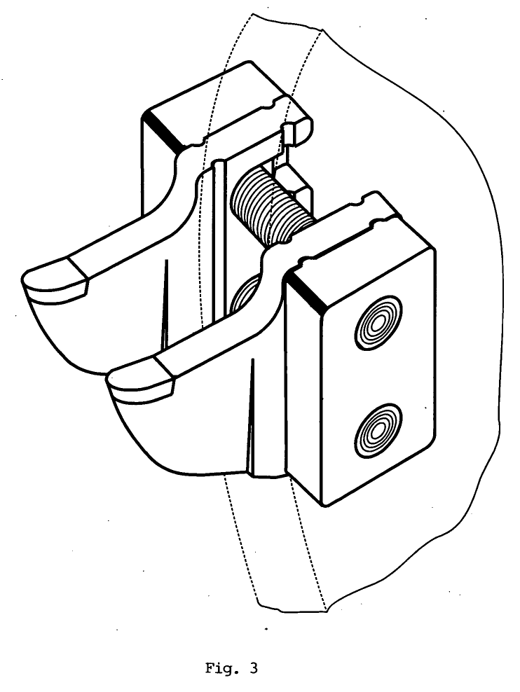

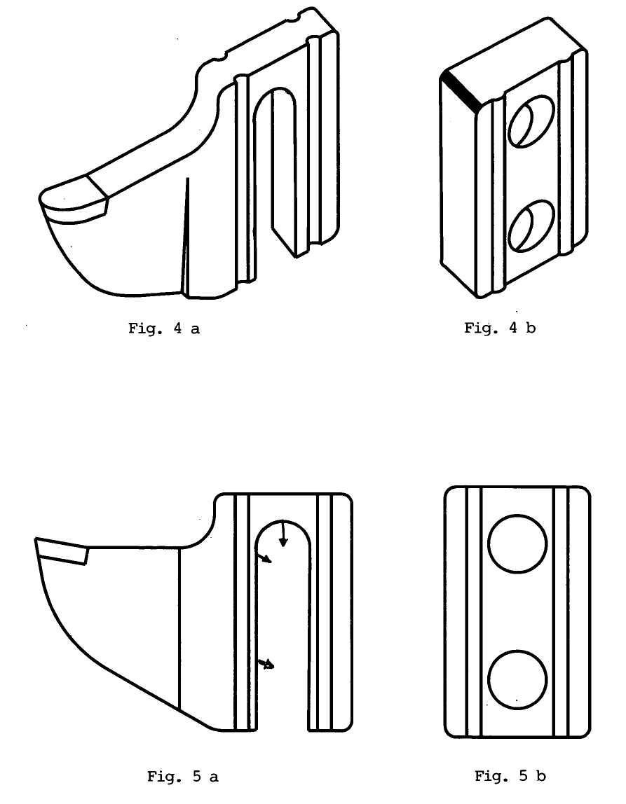

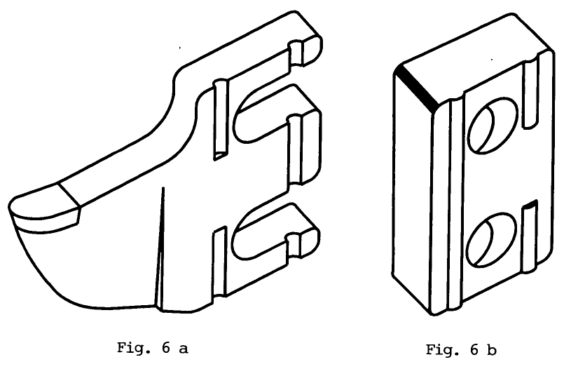

The slot may be opened tangentially as shown in FIGS. 4a and 5a, instead of centripetally, as shown in FIGS. 2a and 3. Note the direction of the slot opening in FIGS. 4a and 5a, however, goes against the rotation when the tooth is cutting. That way, at time of cutting the stump, the contact force pushed against the bolts will ensure that the tooth will not fall off. The contact force is shown by three small arrows in FIG. 5a.

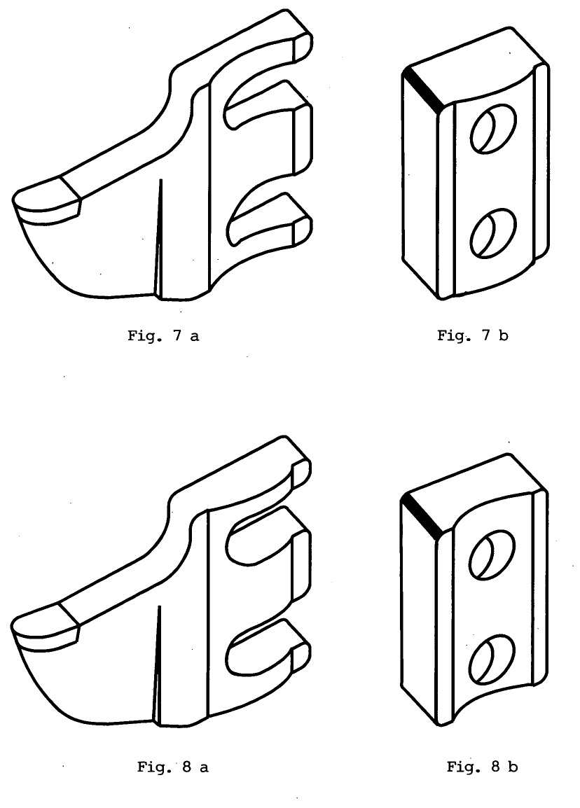

FIGS. 7a, 7b, 8a and 8b show that, instead of ribs/grooves serving as alignment and increasing clamping effect, the contact surface can be made into curvature.

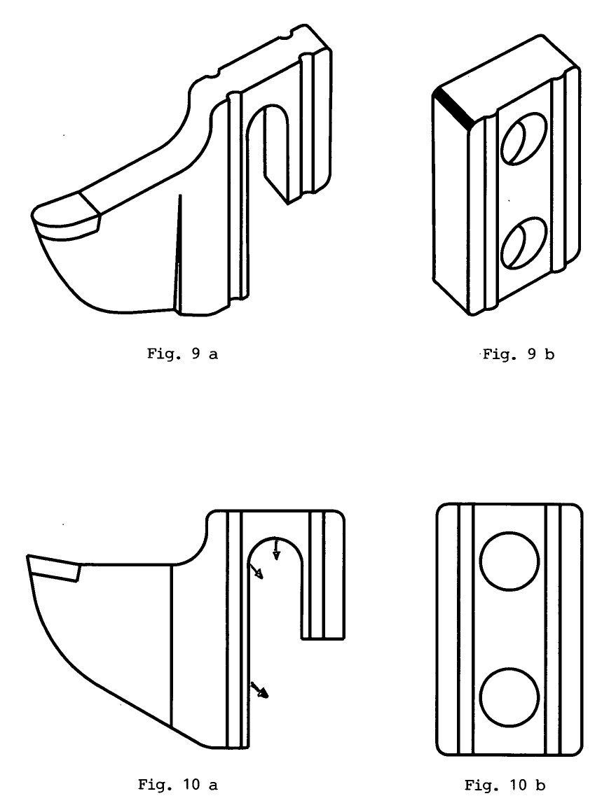

FIGS. 9a and 10a show that the slot can be made even wider, making the work of replacement even easier. However, with the ribs/grooves design, the clamping power is not affected. Furthermore, the contact force pushing towards the bolts at time of cutting is shown by the three small arrows in FIG. 10a. Therefore, the wider slot does not affect the clamping power.

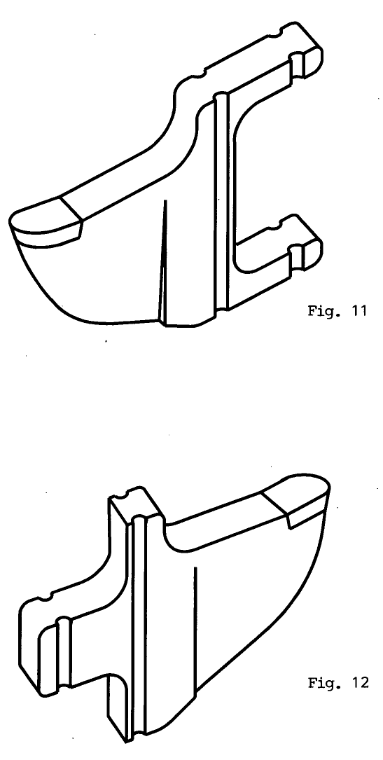

FIGS. 11 and 12 show alternative designs and implementation of how open slots can be formed on a tooth, each maintaining the rib/groove structure. The corresponding holding block is the equivalent of FIG. 9b.

In present invention, ribs are made to the block and grooves are made to the tooth. In practice, the reverse can likely be done, i.e., grooves are made to the block, and ribs are made to the block.

In present invention, a pair of ribs and grooves are shown throughout the drawings. However, just one rib and one groove on the tooth and block may also be enough, depending the specific implementation. More than two ribs and two grooves may be warranted, similarly, depending on the specific implementation.

1. New design and configuration of tree stump cutting tooth and corresponding holding block, comprising:
a. A holding block with holes having a plurality of ribs; and
b. A tooth having a plurality of slots for receiving bolts and a plurality of corresponding grooves.

2. The design of claim 1, wherein one side of said holding block is curved outward and one side of said tooth is curved inward, so as to form a curved matching interface.

3. The design of claim 1, wherein one side of said holding block is curved inward and one side of said tooth is curved outward, so as to form a curved matching interface

4. The design of claim 1, wherein said slots have the opening in the centripetal direction.

5. The design of claim 1, wherein said slots have the opening in the tangential direction.

6. The design of claim 1, wherein said tooth has a length of mid-portion extending centripetally, forming two wide-angled slots.
